(19) United States
(12) Patent Application Publication
(10) Pub. No.: US 2013/0249763 A1
(43) Pub. Date: Sep. 26, 2013

(54) COMMUNICATION ANTENNA FOR THIN-FILM MOBILE DEVICE

(71) Applicant: SEN-KUNG HSU, New Taipei City (TW)

(72) Inventor: SEN-KUNG HSU, New Taipei City (TW)

(21) Appl. No.: 13/429,445

(22) Filed: Mar. 26, 2012

(51) Int. Cl. H01Q 1/52; H01P 11/00

(52) U.S. Cl. 343/842; 29/600

(57) ABSTRACT

A communication antenna for a thin-film mobile device particularly relates to an antenna arranged on a cover of the mobile device and having an enhanced effect on transmission or reception of signals. The communication antenna connected to a transceiver circuit of the mobile device includes a plastic substrate, a metal layer joining an interface layer coated on the plastic substrate, wherein the metal layer is engraved with a separating loop that may have various shapes and areas such that the separating loop encloses an antenna that may have various shapes and areas, and an insulating protective layer coated on the engraved metal layer so as to cover the metal layer and the separating loop. Thereby, the mobile device has an enhanced effect on transmission or reception of signals and provides prevention of electromagnetic interference (EMI).

### BACKGROUND OF THE DISCLOSURE

a) Field of the Disclosure

The invention relates to a communication antenna for a thin-film mobile device, and more particularly, to a communication antenna for a thin-film mobile device, connected to a transceiver circuit of the mobile device so as to have an enhanced effect on transmission or reception of signals and provide prevention of electromagnetic interference (EMI).

b) Brief Description of the Related Art

Typically, a mobile device, such as cell phone, contains an antenna installed in an inner circuit thereof. The inner circuit is too slight to contain the antenna with a large area, and thus this arrangement has an unfavorable effect on transmission or reception of signals. In view of this disadvantage, the invention proposes an improved antenna for a mobile device having an enhanced effect of transmission or reception of signals.

### SUMMARY OF THE DISCLOSURE

The present invention is directed to a communication antenna for a thin-film mobile device, connected to a transceiver circuit of the mobile device so as to have an enhanced effect on transmission or reception of signals and provide prevention of electromagnetic interference (EMI).

The communication antenna for a thin-film mobile device, connected to a transceiver circuit of the mobile device, includes a plastic substrate, a metal layer joining an interface layer coated on the plastic substrate, wherein the metal layer is engraved with a separating loop that may have various shapes and areas such that the separating loop encloses a thin-film antenna that may have various shapes and areas, and an insulating protective layer of a polymer or low-molecular-weight polymer coated on the engraved metal layer so as to cover the metal layer and the separating loop. Thereby, the mobile device has an enhanced effect on transmission or reception of signals and provides prevention of electromagnetic interference (EMI).

In one embodiment, the metal layer is formed by melting a metal material in a high temperature using high-voltage arcs so as to form a metal liquid, next spraying and coating the melted metal liquid over the plastic substrate using a high pressure gas, wherein the interface layer acting as a media between plastic and metal is coated on the plastic substrate in advance such that the melted metal liquid joins the plastic substrate, and thereby the metal layer that is electrically conductive can be formed.

In one embodiment, the metal layer is made of a zinc-containing or aluminum-containing alloy.

In one embodiment, the interface layer for adhesion is made of a resin adhesive, such as Acrylic resin, epoxy resin, silicone resin, PU resin or thermoplastic resin, used for being sprayed or coated on a surface of the plastic substrate.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1 is a three dimensional view in accordance with the present invention.

FIG. 2 is a cross sectional view in accordance with the present invention.

FIG. 3 is another cross sectional view in accordance with the present invention.

FIG. 4 is a flow chart in accordance with an embodiment of the present invention.

FIG. 5 is a schematic view of connection with a transceiver circuit in accordance with an embodiment of the present invention.

FIG. 6 is a schematic view of a finished product in accordance with an embodiment of the present invention.

FIG. 7 is a schematic view of another finished product in accordance with an embodiment of the present invention.

FIG. 8 is a schematic view of the other finished product in accordance with an embodiment of the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

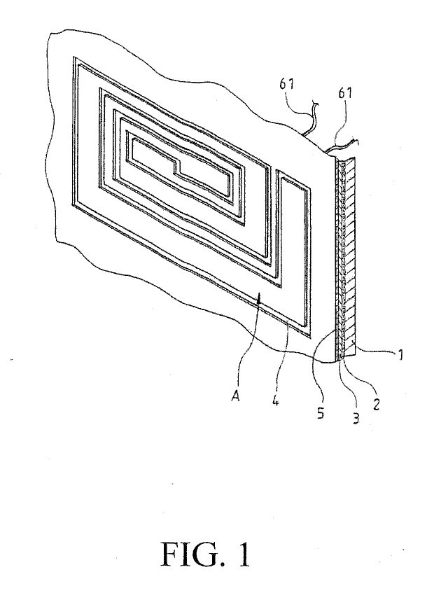

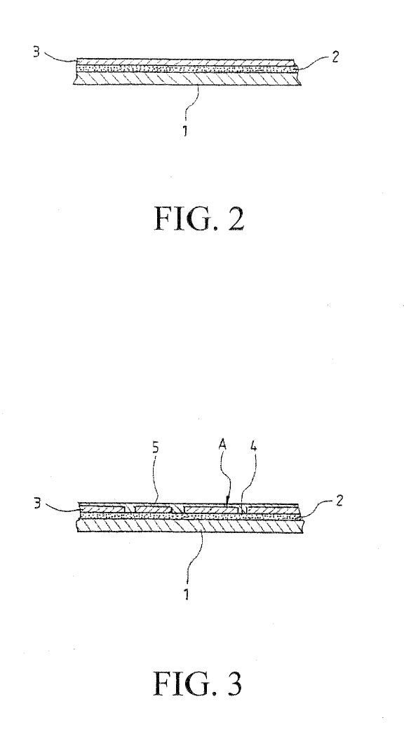

FIGS. 1, 2 and 3 are three dimensional and cross sectional views in accordance with the present invention. Referring to FIGS. 1,2 and 3, in accordance with the present invention, an antenna for a thin-film mobile device, connected to a transceiver circuit of the mobile device, includes a plastic substrate 1, a metal layer 3 joining an interface layer 2 coated on the plastic substrate 1 and an insulating protective layer 5 covering the metal layer 3. The plastic substrate 1 can be a cover of the mobile device, formed by an injection molding process, wherein the cover may have any various shape. The metal layer 3 is engraved with a separating loop 4 that may have various shapes and may have a thickness flush with the interface layer 2 such that the separating loop 4 encloses an antenna A that may have various shapes. The insulating protective layer 5 is coated on the engraved metal layer 3 so as to cover the metal layer 3 and the separating loop 4. Thereby, the mobile device has an enhanced effect on transmission or reception of signals.

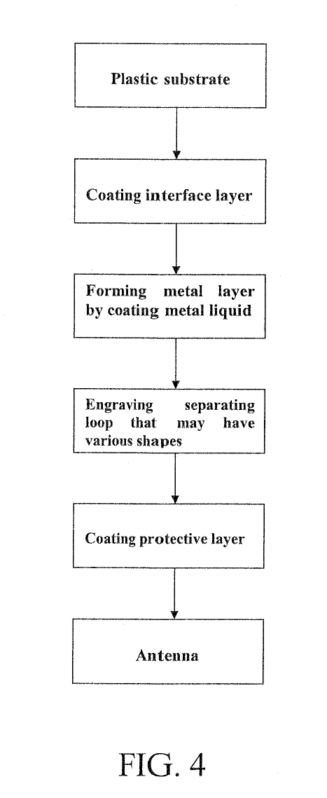

FIG. 4 is a flow chart in accordance with an embodiment of the present invention. Referring to FIGS. 3 and 4, a method for forming an antenna, in accordance with the present invention, includes the following processes:

1. forming a plastic substrate 1 formed by an injection molding process, wherein the plastic substrate 1 can be a cover of a mobile device and the cover may have any various shape;

2. coating an interface layer 2 on the plastic substrate 1, wherein the interface layer 2 for adhesion can be made of a resin adhesive, such as Acrylic resin, epoxy resin, silicone resin, PU resin or thermoplastic resin, used for being sprayed or coated on a surface of the plastic substrate 1;

3. melting a metal material, such as a zinc-containing or aluminum-containing alloy, in a high temperature using high-voltage arcs so as to form a metal liquid, and next spraying and coating the melted metal liquid over the plastic substrate 1 using a high pressure gas, wherein the interface layer 2 acting as a media between plastic and metal is coated on the plastic substrate 1 in advance such that the melted metal liquid joins the plastic substrate 1, and thereby a metal layer 3 that is electrically conductive can be formed;

4. engraving the metal layer 3 so as to form a separating loop 4 that may have various shapes and areas and may have a thickness flush with the interface layer 2 such that the separating loop 4 enclose an antenna A that may have various shapes; and

5. coating a protective layer 5 on the metal layer 3 engraved with the separating loop 4 so as to cover the metal layer 3 and the separating loop 4, wherein the protective layer 5 can be an insulating material used for paint spraying or baking, wherein a resin coating of a polymer or low-molecular-weight polymer can be applied so as to form a packaging insulator before the protective layer 5 is coated at the antenna A and separating loop 4 both engraved from the metal layer 3.

In accordance with the above method, the antenna A arranged on the cover of the mobile device connects to a transceiver circuit of the mobile device and is arranged at an outside of the mobile device. Thereby, the metal layer 3 does not have a serious impact on transmission or reception of signals and the mobile device has an enhanced effect on transmission or reception of signals. Besides, the metal layer 3 around the antenna A provides prevention of electromagnetic interference (EMI).

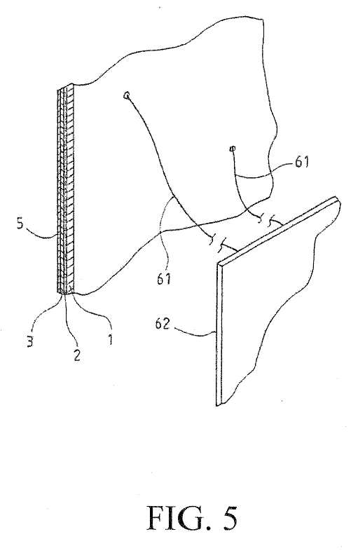

FIG. 5 is a schematic view of connection with a transceiver circuit in accordance with an embodiment of the present invention. Referring to FIGS. 1 and 5, after the antenna A is completed, each conductive wire 61 passing through the plastic substrate 11 has an end connecting with the antenna A and the other end connecting with a transceiver circuit 62 inside the mobile device. Thereby, the transceiver circuit 62 has an enhanced effect on transmission or reception of signals through the antenna A. Besides, the metal layer 3 around the antenna A provides prevention of electromagnetic interference (EMI).

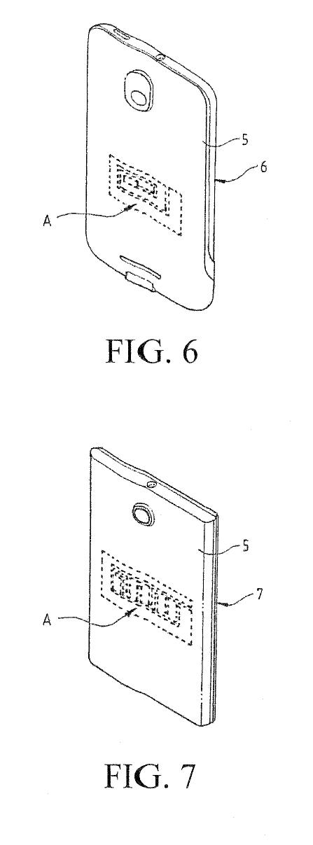

FIG. 6 is a schematic view of a finished product in accordance with an embodiment of the present invention. Referring to FIGS. 1 and 6, after the cover is assembled with a mobile device 6, such as mobile phone, the antenna A can be concealed at a backside of the cover of the mobile device 6 such that the antenna A is not covered by the metal layer 3 and thus has an enhanced effect on transmission or reception of signals. The antenna A is covered by the protective layer 5, and thus the mobile device 6 has an artistically smooth surface.

FIG. 7 is a schematic view of another finished product in accordance with an embodiment of the present invention. Referring to FIGS. 1 and 7, after the cover is assembled with another mobile device 7, such as mobile phone, the antenna A can be concealed at a backside of the cover of the mobile device 7 such that the antenna A is not covered by the metal layer 3 and thus has an enhanced effect on transmission or reception of signals. The antenna A is covered by the protective layer 5, and thus the mobile device 7 has an artistically smooth surface.

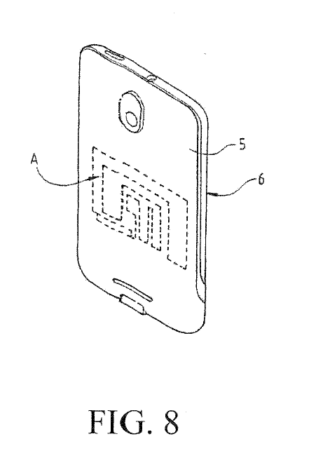

FIG. 8 is a schematic view of the other finished product in accordance with an embodiment of the present invention. Referring to FIGS. 1 and 8, the antenna A can be engraved with various shapes and areas based on communication sensitivity. In this embodiment, the antenna A has relatively large area to meet the effect on transmission or reception of signals for the mobile device 6.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

In summary, the invention proposes the antenna connected to the transceiver circuit of the mobile device is composed of the plastic substrate, the metal layer joining the plastic substrate and the separating loop engraved in the metal layer such that the effect on transmission or reception of signals can be enhanced and electromagnetic interference (EMI) can be prevented. Accordingly, the useful design is believed to be an innovative invention with application for a patent and the patent application is hoped to be granted soon.

What is claimed is:

1. A communication antenna for a thin-film mobile device, comprising:
an antenna on a cover of the mobile device; and
a metal layer around the antenna, for prevention of an electromagnetic wave, wherein a separating loop is between the antenna and the metal layer, for separating the antenna and the metal layer.

2. A method for forming a communication antenna for a thin-film mobile device, comprising:
forming a plastic substrate formed by an injection molding process, wherein the plastic substrate acts as a cover of a mobile device;
coating an interface layer on the plastic substrate;
coating a metal layer joining the plastic substrate using the interface layer;
engraving the metal layer so as to form a separating loop having a thickness flush with the interface layer and enclosing an antenna; and
coating a protective layer at the metal layer, the separating loop and the antenna.

3. The method of claim 2, wherein said coating the metal layer comprises melting a metal material in a high temperature using high-voltage arcs so as to form a metal liquid and then spraying and coating the melted metal liquid over the plastic substrate coated with the interface layer.

4. The method of claim 3 further comprising said spraying and coating the melted metal liquid using a high pressure gas.

5. The method of claim 2, wherein the metal layer comprises a zinc-containing or aluminum-containing alloy.

6. The method of claim 2, wherein the interface layer for adhesion comprises a resin adhesive of Acrylic resin or epoxy resin, used for being sprayed or coated on a surface of the plastic substrate.

7. The method of claim 2, wherein the interface layer for adhesion comprises a resin adhesive of silicone resin, PU resin or thermoplastic resin, used for being sprayed or coated on a surface of the plastic substrate.

8. The method of claim 2 further comprising applying a resin coating of a polymer or low-molecular-weight polymer to the separating loop and antenna both engraved from the metal layer so as to form a packaging insulator.

9. The method of claim 2, wherein the protective layer coated at the metal layer, the separating loop and the antenna comprises an insulating material used for paint spraying or baking.
